(19) United States
(12) Patent Application Publication
(10) Pub. No.: US 2013/0327690 A1
(43) Pub. Date: Dec. 12, 2013

(54) HYDRAULIC FLUID FILTER HAVING A BYPASS VALVE

(71) Applicant: Ford Global Technologies, LLC, Dearborn, MI (US)

(72) Inventors: MICHAEL GEORG FIGURA, DORMAGEN (DE); VOLKER PETERMANN, COLOGNE (DE)

(21) Appl. No.: 13/914,302

(22) Filed: Jun. 10, 2013

(30) Foreign Application Priority Data
Jun. 11, 2012 (DE) 102012209705.8

(51) Int. Cl. B01D 35/147

(52) U.S. Cl. CPC B01D 35/1475
USPC 210/133

(57) ABSTRACT

A fluid filter having a filter basket is described. The filter basket defines a filter interior through a first wall, formed of a filter element, which surrounds the filter interior, and a second wall, located at the bottom of the filter basket, accommodating an inlet to receive a fluid. The second wall includes a bypass channel extending into the filter interior, defining a bypass inlet therein, which in turn includes a bypass valve for routing the fluid to bypass the filter element based on the pressure differential across the filter. Further, the second wall includes at least one collecting pocket where filtered contaminants of the fluid can deposit and accumulate. Here, the bypass inlet extends above the second wall, placing the bypass inlet above the at least one collecting pocket.

### TECHNICAL FIELD

Embodiments of the present disclosure generally relate to filters for flowing fluid, and, more specifically, to filters adapted to keep a hydraulic system substantially free from entrained solid substances/particles.

### BACKGROUND

In hydraulic systems, such as a power steering unit of a vehicle, the hydraulic fluid, which may be hydraulic oil, should be kept substantially free of entrained solid matter, to ensure effectively smooth and error-free operation. For that purpose, filters are employed to filter and segregate impurities within the fluid, ensuring that the fluid maintains a desired quality in terms of the level of entrained particles. The filter within the hydraulic system should have a mesh size chosen to remove all particles larger than a selected size. A problem arises at low operating temperatures, however, as increased fluid viscosity may prevent smooth fluid flow through the mesh. Further, a fine mesh tends to clog after long operation, blocking the filter.

To overcome this problem, bypass valves are used in some conventional hydraulic systems, which bypass the filter when required to maintain a sufficient amount of hydraulic fluid in the system. Bypassing the filter, however, presents a major disadvantage, as conventional systems are unable to prevent the sediments/contaminants from intruding into the hydraulic system.

Considering the problems mentioned above, there exists a need for a fluid filter for hydraulic systems, which can effectively segregate fluid contaminants and prevent them from entering the hydraulic system.

### SUMMARY

The present disclosure provides a filter for a fluid flowing through a hydraulic system, which substantially segregates any sediments or impurities contained within the fluid entering the filter, and prevents those impurities from intruding into the hydraulic system.

According to an aspect, a fluid filter is disclosed having a filter basket that defines a filter interior. The filter basket has a first wall and a second wall. The first wall is formed of a filter element and surrounds the filter interior, while the second wall, located at the bottom of the filter basket, accommodates an inlet to receive a fluid into the filter interior. A bypass channel extends from the second wall into the filter interior and defines a bypass inlet therein. More specifically, the bypass channel includes a bypass valve adapted to route the fluid to bypass the filter element based on the pressure differential between the filter interior, and an exterior space, surrounding and proximate to the filter basket. Further, the second wall includes at least one collecting pocket where filtered contaminants of the fluid can deposit and accumulate. Structurally, the bypass inlet extends above the second wall, placing the bypass inlet above the at least one collecting pocket.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

FIG. 1 is a cross-sectional view of a filter for a fluid flowing through a hydraulic system, and a housing incorporating the filter, according to an embodiment of the present disclosure.

FIG. 2 is a detailed cross-sectional view of the filter of FIG. 1.

FIG. 3 is a top view of the filter of FIG. 1.

### DETAILED DESCRIPTION OF ILLUSTRATIVE EMBODIMENTS

The following detailed description illustrates aspects of the disclosure and its implementation. This description should not be understood as defining or limiting the scope of the present disclosure, however, such definition or limitation being solely contained in the claims appended thereto. Although the best mode of carrying out the invention has been disclosed, those in the art would recognize that other embodiments for carrying out or practicing the invention are also possible.

The fluid flowing in hydraulic systems must be filtered properly, to segregate any contaminants present within the fluid during the fluid influx, and to prevent those contaminants from intruding into the hydraulic system. Difficulties in smooth operation, most often caused by clogging, may be experienced if such contaminants enter the hydraulic system. The present disclosure solves that problem by providing an efficient filter for fluids in hydraulic systems, as well as a fluid reservoir.

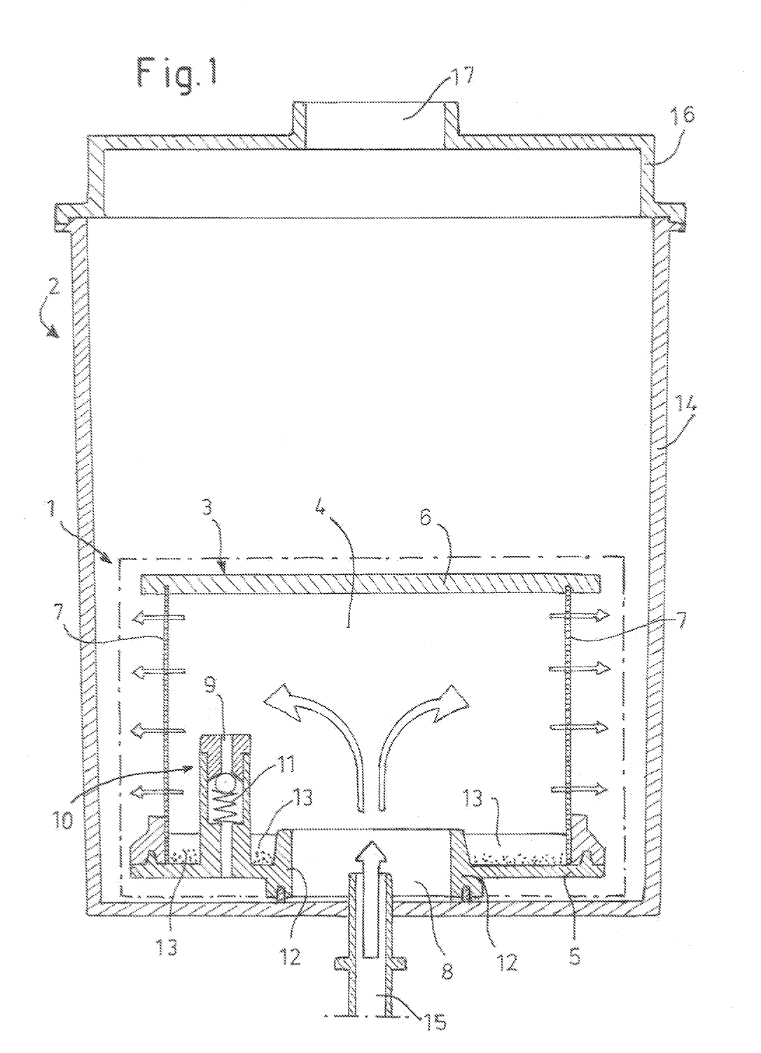

FIG. 1 is a cross-sectional view of an exemplary filter for a fluid flowing through a hydraulic system, and a housing incorporating the filter, according to an embodiment of the present disclosure. As shown, a filter 1, enclosed within a reservoir 2, includes a filter basket 3 having a substantially cylindrical shape, though other suitable shapes may also be contemplated. The filter basket 3 includes an inner space referred to as filter interior 4, and includes a first wall, referred to as a side wall 7, surrounding and substantially defining the filter interior 4. Besides the side wall 7, an outer portion of the filter basket 3 is defined by a second wall located at the basket's bottom, referred to as a bottom wall 5, and a top wall 6, at the top and bottom of the reservoir 2.

The reservoir 2 stores the fluid to be circulated in the hydraulic system Structurally, the reservoir 2 includes a housing 14, having an inlet 15 for receiving fluid from the system, as well as an outlet (not shown) for discharging the fluid. The inlet 8 of the filter 1 substantially aligns with, and is connected in a fluid-tight manner to the inlet 15 of the reservoir 2. Also, an assembly of the inlet 8 and the housing 14 provides for locking and retaining the filter element (side wall 7) within the housing 14. The housing 14 also has a cover 16 having an inlet/opening 17 through which the fluid can be filled into the reservoir 2.

In operation, hydraulic fluid flows through the inlet 15 of the housing 14, and eventually, through the inlet 8 of the filter 1, to enter the filter interior 4 of the filter basket 3. On entering the filter interior 4, the fluid is distributed in a radially symmetrical manner to the different portions of the filter interior 4, as indicated by the side arrows in FIG. 1. In the usual operating state, when the viscosity of the fluid is sufficiently low, the fluid flows out through the side wall 7 after being filtered by the filter element of the side wall 7.

During operation, the filter interior 4 is adapted to receive a fluid influx, such as of hydraulic oils, power steering fluids, brake fluids, or other conventional fluids, adapted to flow through the hydraulic system. Accordingly, the filter basket 3 has an inlet 8 that is meant to receive fluids. Specifically, the inlet 8 is provided in the bottom wall 5 of the filter basket 3, as shown, and may be in the form of an aperture extending through the bottom wall 5 and communicating with the filter interior 4. The size and shape of the inlet 8 may vary, based on parameters such as the flow rate and volume of the fluid entering the filter interior 4.

The side wall 7 is formed of a filter element. In a preferred embodiment, the filter element is a Nylon woven fabric having a mesh width ranging from to _to_μm, and thus, because of a relatively small sized filter mesh, the filter 1 may be referred to as a fine filter. Other suitable materials for the filter element may also be contemplated. In some embodiments, the top wall 6 of the filter basket 3 is formed of a similar filter element as well, substantially increasing the filtering regions within the filter basket 3.

More particularly, the side wall 7 forms an outlet of the filter basket 3, and is oriented in a substantially vertical configuration. Usually, fluid enters the filter basket 3 through the inlet 8 and leaves through the side wall 7, having contaminant particles retained in the filter basket 3 by the filtering action of the side wall 7. The sedimentary particles, initially lodge against the inner side of the side wall 7, but they may eventually detach from the side wall 7 and fall to the bottom portion of the filter basket 3 by virtue of gravity. Where the filter 1 is used in an automotive application, operating vibrations may facilitate that action . . . , Removing contaminants trapped against the filter prevents clogging, but simply allowing the particles to drop to the bottom of filter basket 3 may not the particles from being again drawn into the mainstream fluid flow. That result is particularly likely if the particles come to rest in an area within the normal flow path within the filter basket 3.

To address that concern, a retaining wall 12 projects upward from the bottom wall 5 into the filter interior 4. This wall projects upward only a short distance, which could be about _% of the height of side wall 7. The inner sides of the retaining wall 12 may define the inlet 15. The outer sides of the retaining wall 12 cooperate with the inner surface of side wall 7 to define collecting pockets 13, positioned at the natural location to collect sediments or solid contaminant particles that separate from the side wall 7 and descend to the bottom wall 5. The interior of the collecting pockets 13 are not subject to fluid flow within the filter basket 3, and thus these areas can be termed dead flow zones, where the fluid is substantially stagnant. As a result, the collecting pockets 13 collect the descended particles as sediments. Once collected and accumulated in the pockets 13, those sediments are isolated from the fluid flow and prevented from escaping into the hydraulic system.

Accumulation of particles on side wall 7 decreases the through the that wall, leading to an increase in the pressure differential across the filter 1. Without intervention, the reduced flow could starve the hydraulic system of fluid, which might endanger functions such as steering or braking That problem is addressed by the present disclosure, as set out below

Flow reduction caused by filter clogging is solved by a bypass channel 9, provided within the filter basket 3, which offers a fluid path around the filter element, without allowing sediment to escape from the filter element. Bypass element 10 generally takes the form of a tubular element extending upward from the bottom wall 5, having a bypass channel 9 extending through it, from the inside of filter basket 3, through bottom wall 5, and into the portion of reservoir 2 outside filter basket 3. The upper end of bypass element 10 lies above the level of retaining wall 12, within a region of the filter interior 4 where the fluid undergoes relatively minimal turbulence. Therefore, the density of sediments or other solid particles present within the fluid is quite low around the region proximate to the inlet of the bypass channel 9. Hence, only a low probability exists that particles and impurities will escape the filter interior 4 through the bypass channel 9.

In a preferred embodiment, the bypass channel 9 extends to a level substantially equal to half the height of the filter basket 3 that spans between the top wall 6 and the bottom wall 7. That separation between the inlet of bypass channel 9 and the collecting pockets 13 ensures that flow into bypass channel 9 will most likely not entrain particles or sediment from the collecting pockets in the course of its flow out of the filter interior 4.

The flow through bypass channel 9 is controlled by a bypass valve 11, made up of a normally closed check valve. Those of skill in the art will recognize that check valves can be formed in a number of variations. One embodiment, illustrated in FIG. 1, includes a ball, biased against a conical seat by a resilient means, such as a coil spring. The valve components can be carried in a well or cavity formed in bypass element 10, the cavity opening onto the lower portion of bypass channel 9, and communicating with the filter interior 4 via a passage formed in a plug fit into the upper end of bypass element 10.

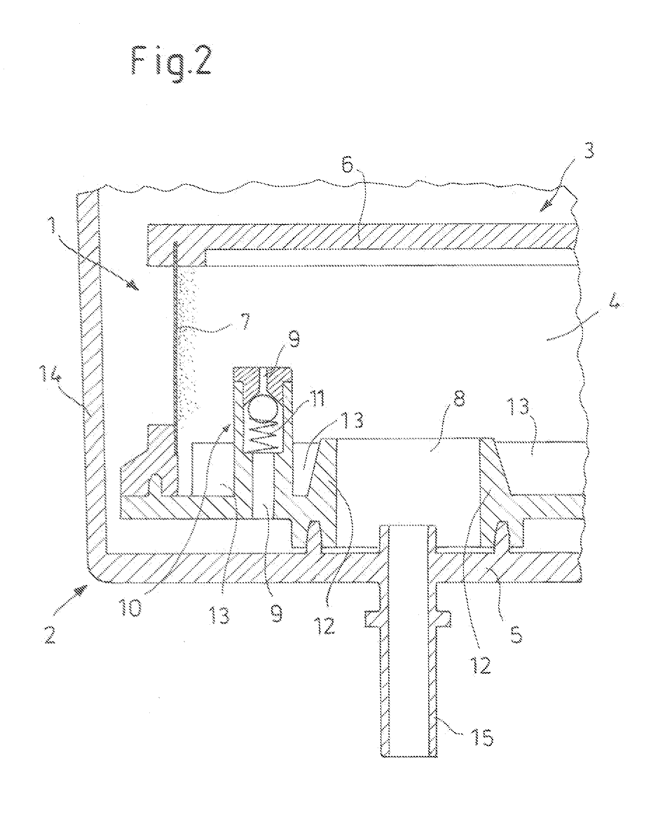

Details of the bypass valve 11 are best seen in FIG. 2. As shown there, when fluid pressure inside filter interior 4 reaches a level sufficient to open the bypass valve 11, the ball is urged away from its seat, allowing fluid flow through bypass channel 9. Fluid thus bypasses side wall 7, flowing directly from inlet 15 to the reservoir 2. A number of variation in structure and composition are known and available to those in the art. For example, the resilient means may be a coil spring or any of a variety of other resilient arrangements. This element may be formed of a metallic substance, such as spring steel, or a polymer.

Operational parameter of bypass valve 11 will vary due to a number of factors. For example, the threshold check valve value may depend on parameters such as the volume and the flow rate of the fluid entering the filter interior through the inlet 8, and the size and dimensions of the filter basket 3. In a similar manner, the bypass valve 11 is automatically closed when the pressure differential between the filter interior 4 and the space surrounding the filter basket 3 falls below the pre-determined threshold value. the action of the bypass element 10 and bypass valve 11 ensures, even when filter clogging produces extremely high pressure, the filter element of the side wall 7 does not split and is not destroyed as a result Simultaneously, is the bypass structure ensures that a sufficient amount of fluid enters the filter interior 4 at all points of time.

Additionally, in a case where the temperature of the hydraulic fluid entering the filter basket 3 is substantially low, the fluid may have a relatively high viscosity, due to which, the fluid may experience high resistance from the filter element of the side wall 7, while emerging out of the side wall. In that case, a relatively high differential pressure builds up between the filter interior 4 and the space surrounding and proximate the filter basket. In response to the built high pressure, the bypass element 10 bypass valve 11 disposed within the bypass channel 9 opens, and the fluid is able to leave the filter interior 4 through the bypass channel 9, bypassing the filter element of the side wall 7.

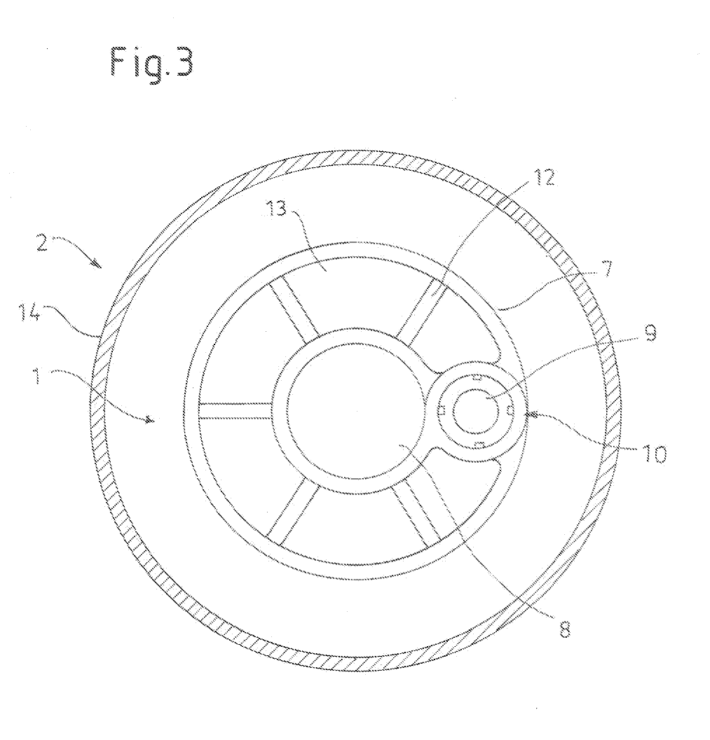

FIG. 3 is a top view of the reservoir 2 of FIG. 2, incorporating the filter 1. Here, the collecting pockets 13 can be further understood as an array of pie-shaped wells extending radially from the inlet 8 as. In the illustrated layout, six collecting pockets 13 are shown, but that number should not be viewed as a limitation, but purely as being exemplary in nature. Accordingly, the collecting pockets 13 can be structured in a number of designs. For example, the collecting pockets 13 may be narrower and/or more in number, such that the presence, and, more particularly, the flow of the hydraulic fluid in those regions may be restricted. Such a configuration may facilitate increased isolation of the impurities deposited in those regions from being stirred up again because of flow turbulence, vibrations, etc. Other layouts may be contemplated as well by those in the art.

The housing 14 of the reservoir 2 and the filter basket 3 can be viewed to have substantially cylindrical shapes, as disclosed above. Moreover, the inlet 8 of the filter 1, adapted to receive the fluid into the filter basket 3, is preferably positioned at the bottom central portion of the filter basket 3, to allow a radially symmetric distribution of the fluid within the filter interior 4.

The filter of the present disclosure and the storage container incorporating the filter, are not limited to the embodiments described above, and therefore, identically acting embodiments or obvious variations of the embodiments mentioned herein are also possible.

Further, the filter can be used in conjunction with any hydraulic system, such as the power steering fluid circuit for a power steering unit of a vehicle, the brake fluid in the braking unit of a vehicle, etc.

Although the current invention has been described comprehensively, in considerable details to cover the possible aspects and embodiments, those skilled in the art would recognize that other versions of the invention are also possible.

What is claimed is:

1. A fluid filter, comprising:
a filter basket defining a filter interior, the filter basket including:
a first wall surrounding the filter interior, formed of a filter element for filtering contaminant particles from the fluid;
a second wall located at the bottom of the filter basket and defining an inlet to receive a fluid into the filter interior,
wherein the second wall and the first wall cooperate to define at least one collecting pocket therebetween, positioned for receiving contaminant particles dropping from the first wall; and
a bypass valve having , the bypass valve including
an inlet positioned in the filter interior above the level of the collecting pockets;
an outlet outside the filter basket;
a bypass channel extending from the inlet to the outlet; and
a bypass valve for permitting flow from the inlet to the outlet when fluid pressure within the filter interior exceeds a threshold value.

2. The filter of claim 1, wherein the bypass valve is a check valve.

3. The filter of claim 1, wherein the bypass valve includes
a valve seat, generally conical in form;
a ball, positioned to rest in the valve seat; and
resilient means for biasing the ball against the seat with a force sufficient to resist the application of the threshold fluid pressure.

4. The filter of claim 1, wherein the filter element is formed of Nylon woven fabric having a mesh width of about 18 μm.

5. A storage container having a housing that surrounds the filter of claim 1, wherein the housing has an inlet for receiving the fluid and an outlet for discharging the fluid, and wherein the inlet of the filter aligns with, and is connected in a fluid-tight manner to the inlet of the storage container.
